(19) United States
(12) Patent Application Publication
(10) Pub. No.: US 2012/0082014 A1
(43) Pub. Date: Apr. 5, 2012

(54) WRIST WORN DEVICE

(75) Inventor: JIN-SHI LAI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., Shenzhen City (CN)

(21) Appl. No.: 12/975,279

(22) Filed: Dec. 21, 2010

(30) Foreign Application Priority Data
Sep. 30, 2010 (CN) 201010298246.3

(51) Int. Cl. G04B 37/18; A44C 5/00

(52) U.S. Cl. 368/282

(57) ABSTRACT

A wrist worn device is provided. The wrist worn device includes a case, a back cover, a strap, and two spring pins. The case includes two pairs of spaced lugs. Each of the spaced lugs defines an axle hole. The back cover includes two opposite sidewalls. Each of the sidewalls defines a groove. The strap defines two through holes. Each of the through holes is adjacent to one of the opposite ends thereof. The strap includes two projections. Each of the projections protrudes from one of two opposite ends of the strap and is received in one of the grooves. Each of the spring pins extends through one of the through holes of the strap, and includes two telescoping axles. Each of the axles is received in one of the axle holes.

### BACKGROUND

1. Technical Field

The present disclosure relates to wrist worn devices and, particularly, to a wrist watch.

2. Description of Related Art

A watch is a common wrist worn device. Usually, the strap of a watch is connected to the case of the watch with spring pins. The case is mechanically engaged with the back cover of the watch. When disassembling, the strap is firstly detached from the case, and the back cover is then detached from the case, which is troublesome.

### BRIEF DESCRIPTION OF THE DRAWINGS

The components of the drawings are not necessarily drawn to scale, the emphasis instead being placed upon clearly illustrating the principles of a wrist worn device. Moreover, in the drawings, like reference numerals designate corresponding parts throughout several views.

FIG. 1 is an isometric view of a wrist worn device in accordance with an exemplary embodiment.

FIG. 2 is an exploded, isometric view of the wrist worn device of FIG. 1.

### DETAILED DESCRIPTION

Embodiments of the present disclosure are now described in detail, with reference to the accompanying drawings.

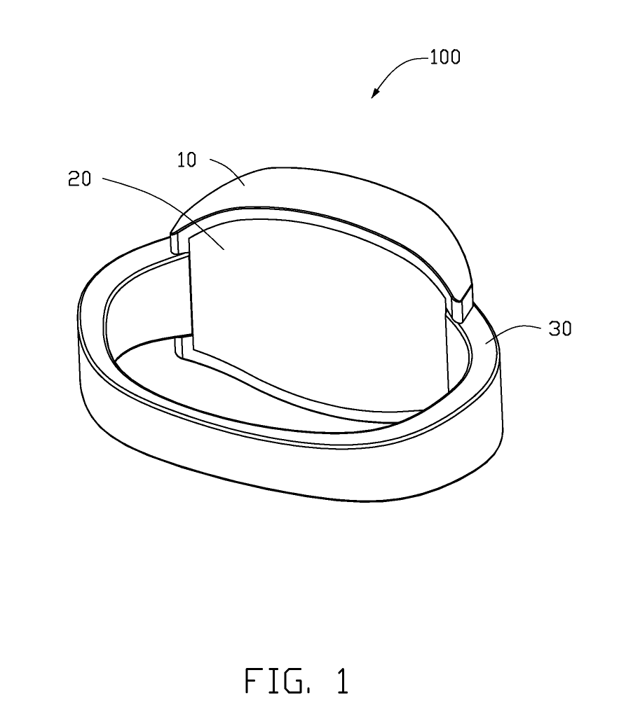

Referring to FIG. 1, a wrist worn device 100 in accordance with an exemplary embodiment is shown. In the embodiment, the wrist worn device 100 is a watch 100. The watch 100 includes a case 10, a back cover 20, and a strap 30. The case 10 and the back cover 20 are fixed together by the strap 30.

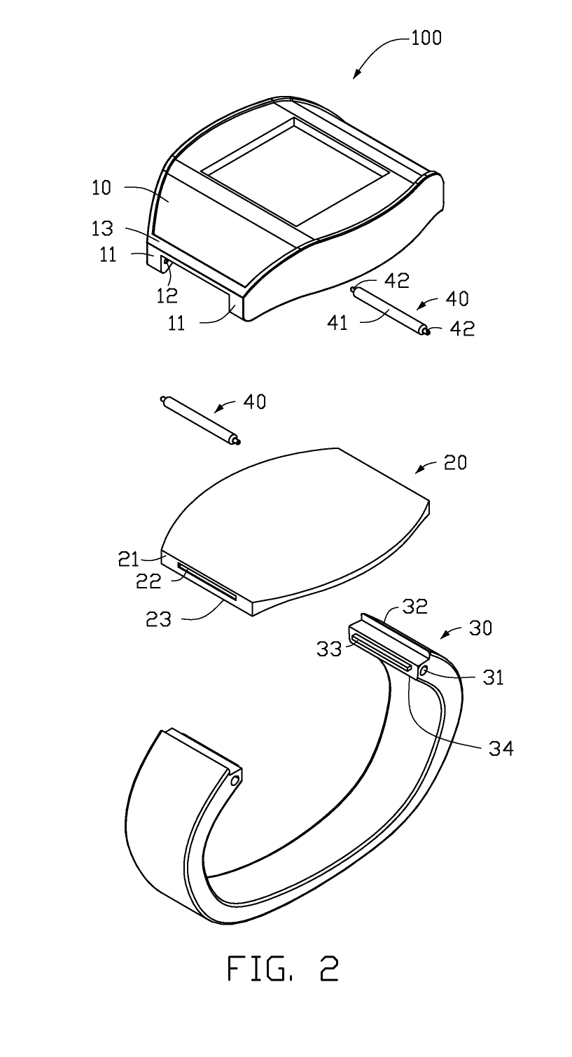

Referring to FIG. 2, two pairs of lugs 11 protrude from the opposite ends of the case 10, respectively. The two lugs 11 in a pair are spaced from each other. Each lug 11 defines an axle hole 12. The back cover 20 includes two opposite sidewalls 21. Each sidewall 21 defines a groove 22. In the embodiment, the groove 22 extends along the widthwise direction of the back cover 20. The case 10 and the back cover 20 cooperatively define a space to receive the required components of the watch 100. The strap 30 defines two through holes 31 respectively adjacent to opposite ends of the strap 30. Each through hole 31 extends along the widthwise direction of the strap 30.

The watch 100 further includes a pair of spring pins 40. Each spring pin 40 includes a rod 41 and a pair of axles 42. The axles 42 protrude from opposite ends of the rod 41 due to being biased by a spring inside the rod 41, and can collapse into the rod 41 when being pushed. In the embodiment, the lengths of the rods 41 are approximately equal to a distance between the spaced lugs 11 in a pair.

The thickness of the strap 30 is the same as the height of each lug 11. Thus, when the case 10 is connected to the strap 30, the upper edge 32 of the strap 30 is flush with the upper edge 13 of the case 10.

Each end of the strap 30 further includes one projections 33. The shape of the projections 33 corresponds to the shape of the grooves 22. Each projection 33 is detachably received in the groove 22. In the embodiment, the thickness of the opposite ends of the strap 30 is the same as that of the back cover 20. When the back cover 20 is fixed to the strap 30, the lower edge 23 of the back cover 20 is flush with the lower edge 34 of the strap 30.

During assembly, each projection 33 of the strap 30 is arranged to be received in the groove 22 of the back cover 20. The spring pins 40 are then inserted into the corresponding through holes 31 of the strap 30. The axles 42 are pushed into the rods 41, allowing the rods 41 to be placed between the two lugs 11. Once aligned with the axle holes 12 of the lugs 11, the axles 42 are urged to move into the respective lugs 11 by the springs, connecting the back cover 20 and the strap 30 to the case 10.

In disassembly, the axles 42 are forced inwardly with a tool to disengage from the axle holes 12 and move away from the lugs 11. The case 10 and the back cover 20 can be removed from the strap 30.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A wrist worn device comprising:
a case comprising two pairs of spaced lugs, each of lugs defining an axle hole;
a back cover comprising two opposite sidewalls, each of the sidewalls defining a groove;
a strap defining two through holes, each of the through holes being adjacent to one of two opposite ends thereof, the strap comprising two projections, each of the projections protruding from one of the opposite ends of the strap and being received in one of the grooves; and
two spring pins, each of the spring pins extending through one of the through holes of the strap, and comprising two telescoping axles, each of the axles being received in one of the axle holes.

2. The wrist worn device as described in claim 1, wherein the shape of the projections is corresponding to that of the grooves.

3. The wrist worn device as described in claim 1, wherein the thickness of the strap is the same as the height of each of the lugs, causing the upper edge of the strap to be flush with the upper edge of the case.

4. The wrist worn device as described in claim 1, wherein the thickness of the opposite ends of the strap is the same as that of the back cover, causing the lower edge of the back cover to be flush with the lower edge of the strap.

5. The wrist worn device as described in claim 1, wherein the length of each of the spring pins is approximately equal to a distance between the spaced lugs in a pair.
